(19) United States
(12) Patent Application Publication
(10) Pub. No.: US 2025/0372860 A1
(43) Pub. Date: Dec. 4, 2025

(54) NON STRAIGHT GROUND PLANE FOR REDUCED HEIGHT ANTENNA ON VEHICLE GLASS

(71) Applicant: GM Global Technology Operations LLC, Detroit, MI (US)

(72) Inventors: Uriel Zvi Odes, Givaat Shmuel (IL); Nahel Eshaq, Rochester, MI (US); Duane S. Carper, Davison, MI (US)

(21) Appl. No.: 18/675,904

(22) Filed: May 28, 2024

(51) Int. Cl. H01Q 1/12; B60R 11/00; B60R 11/02; H01Q 1/32; H01Q 1/48

(52) U.S. Cl. CPC H01Q 1/1278; B60R 11/02; H01Q 1/325; H01Q 1/48; B60R 2011/004; B60R 2011/0063

(57) ABSTRACT

A vehicle includes a window with an antenna assembly. The window includes a glass surface and a metal frame along a perimeter of the glass surface. The antenna assembly is disposed on the glass surface and includes an antenna, a feed point and a ground plane. The antenna has a first end and a second end opposite the first end and is disposed in a visible region of the window. The feed point is located at the first end of the antenna. The ground plane is connected to the antenna at the first end. The metal frame is on top of at least part of the ground plane, and the ground plane is electrically coupled to the metal frame.

### INTRODUCTION

The subject disclosure relates to antennas used in vehicles, and in particular to an antenna assembly that can be implemented in a window that includes defrosting wires.

Vehicles include antennas for communication of various signals, such as radio signals, satellite signals, etc. As antenna size has decreased, the options for antenna placement have increased. Placing an antenna on a back window of a vehicle is however hindered by the presence of defroster wires, which take up a majority of the area of the back window. Accordingly, it is desirable to provide an antenna assembly that can be arranged to fit in, and operate within, a remaining region of the back window not used by the defroster wires.

### SUMMARY

In one exemplary embodiment, an antenna assembly for a window of a vehicle is disclosed. The antenna assembly includes an antenna, a feed point and a ground plane. The antenna is disposed on a glass surface of the window, the antenna having a first end and a second end opposite the first end, the antenna disposed in a visible region of the window. The feed point is located at the first end of the antenna. The ground plane is disposed on the glass surface and is connected to the antenna at the first end, wherein a metal frame of the window is on top of at least part of the ground plane and the ground plane is electrically coupled to the metal frame.

In addition to one or more of the features described herein, the ground plane includes a first recess and a second recess along an edge of the ground plane, the first recess and the second recess defining a connector section of the ground plane.

In addition to one or more of the features described herein, one of the metal frame is on top of the first recess, the second recess and the connector section and a portion of the connector section is in the visible region of the window.

In addition to one or more of the features described herein, wherein the metal frame, the antenna assembly further includes a conductive adhesive layer in the separation gap that electrically couples the ground plane to the metal frame.

In addition to one or more of the features described herein, the conductive adhesive layer includes a urethane adhesive.

In addition to one or more of the features described herein, the antenna is one of a monopole antenna and a dipole antenna.

In addition to one or more of the features described herein, the window is a back window including a set of defroster wires and the antenna is disposed within an antenna region between the set of defroster wires and a top edge of the metal frame.

In another exemplary embodiment, a window of a vehicle is disclosed. The window includes a glass surface, a metal frame along a perimeter of the glass surface, and an antenna assembly disposed on the glass surface. The antenna assembly includes an antenna, a feed point and a ground plane. The antenna has a first end and a second end opposite the first end and is disposed in a visible region of the window. The feed point is located at the first end of the antenna. The ground plane is connected to the antenna at the first end. The metal frame is on top of at least part of the ground plane, and the ground plane is electrically coupled to the metal frame.

In addition to one or more of the features described herein, the ground plane includes a first recess and a second recess along an edge of the ground plane, the first recess and the second recess defining a connector section of the ground plane.

In addition to one or more of the features described herein, one of the metal frame is on top of the first recess, the second recess and the connector section and a portion of the connector section is in the visible region of the window.

In addition to one or more of the features described herein, wherein the metal frame, the window further includes a conductive adhesive layer in the separation gap that electrically couples the ground plane to the metal frame.

In addition to one or more of the features described herein, the conductive adhesive layer includes a urethane adhesive.

In addition to one or more of the features described herein, the antenna is one of a monopole antenna and a dipole antenna.

In addition to one or more of the features described herein, the window is a back window including a set of defroster wires and the antenna is disposed within an antenna region between the set of defroster wires and a top edge of the metal frame.

In yet another exemplary embodiment, a vehicle is disclosed. The vehicle includes a window having a glass surface and a set of defroster wires, a metal frame along a perimeter of the glass surface, wherein a top edge of the metal frame and the set of defroster wires define an antenna region, and an antenna assembly disposed on the glass surface. The antenna assembly includes an antenna, a feed point and a ground plane. The antenna is disposed within the antenna region. The antenna has a first end and a second end opposite the first end and is disposed in a visible region of the window. The feed point is located at the first end of the antenna. The ground plane is connected to the antenna at the first end. The metal frame is on top of at least part of the ground plane and is electrically coupled to the metal frame.

In addition to one or more of the features described herein, the ground plane includes a first recess and a second recess along an edge of the ground plane, the first recess and the second recess defining a connector section of the ground plane.

In addition to one or more of the features described herein, one of the metal frame is on top of the first recess, the second recess and the connector section and a portion of the connector section is in the visible region of the window.

In addition to one or more of the features described herein, wherein the metal frame, the vehicle further includes a conductive adhesive layer in the separation gap that electrically couples the ground plane to the metal frame.

In addition to one or more of the features described herein, the conductive adhesive layer includes a urethane adhesive.

In addition to one or more of the features described herein, the antenna is one of a monopole antenna and a dipole antenna.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a plan view of the window of the vehicle, in an embodiment;

FIG. 3 shows a plan view of the antenna assembly, in an illustrative embodiment;

FIG. 4 shows a close-up view of a left top corner of the window in an illustrative embodiment;

FIG. 5 shows a side view of the window and antenna assembly, in an illustrative embodiment;

FIG. 6 shows a close-up view of the left top corner of the window in another illustrative embodiment; and

FIG. 7 shows a closeup view of the antenna of FIGS. 3, 4 and 6, in an illustrative embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

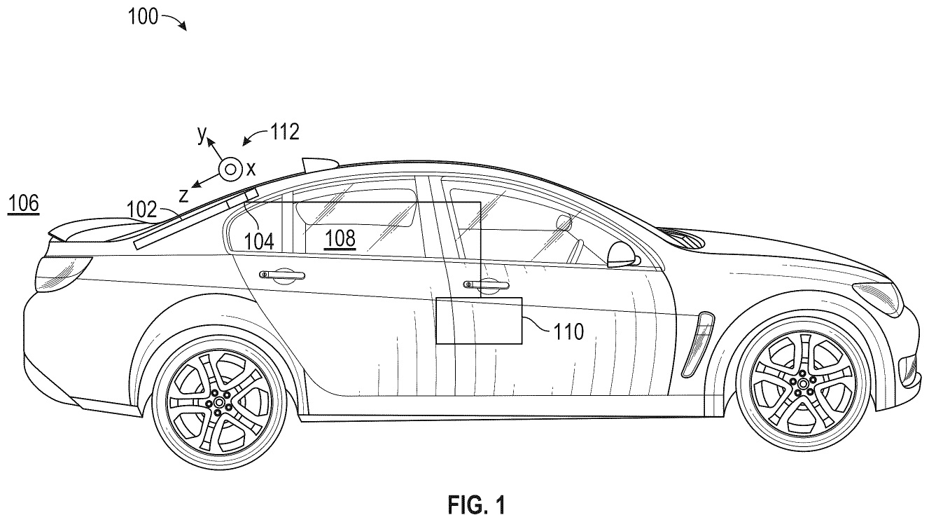

In accordance with an exemplary embodiment, FIG. 1 shows a vehicle 100. The vehicle 100 includes a window 102 having an antenna assembly 104 embedded therein for communication purposes. The window 102 is shown as a back window of the vehicle 100 but, in various embodiments, can be any window of the vehicle. The window 102 separates the space around the vehicle 100 into an outer region 106 outside of the vehicle (i.e., behind the window 102) and an inner region 108 inside of the vehicle (i.e., in front of the window). A coordinate system 112 is shown for the antenna assembly 104. The x-axis and z-axis define a plane of the window 102 and of the antenna assembly 104. Movement or placement of an object along the x-axis is indicated using the terms “left” and “right”, while movement or placement of an object along the z-axis is indicated using the terms “top” and “bottom”. The y-axis is directed out of the plane of the window 102 and into the outer region 106. A placement of a first object “on top of” a second object is indicated by the first object being at a more positive location along the y-axis as the second object.

The antenna assembly 104 is coupled to a communication device 110, such as a Global Positioning Satellite (GPS) or a Global Navigation Satellite System (GNSS) receiver, for example. In various embodiments, the antenna assembly 104 is capable of communicating over a range between 600 Megahertz (MHz) and 6 Gigahertz (GHz).

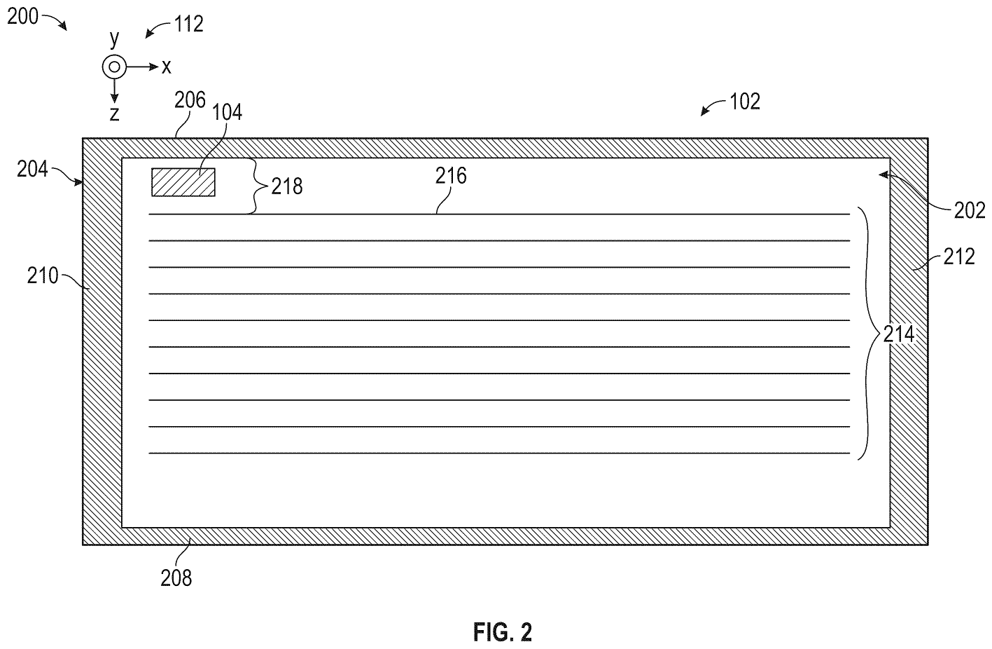

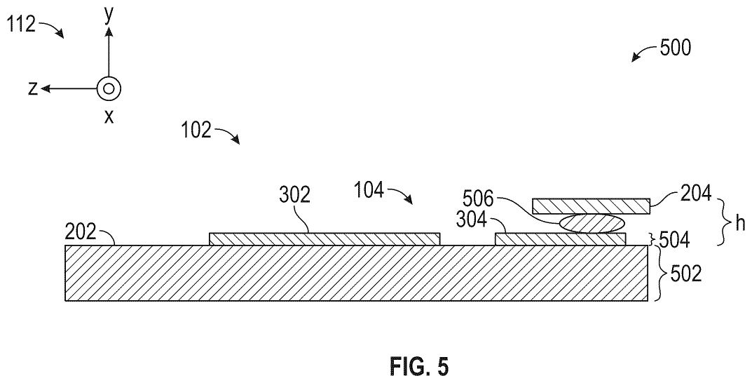

FIG. 2 shows a plan view 200 of the window 102 of the vehicle, in an embodiment. The window 102 includes a glass surface 202 (or glass layer) and a metal frame 204 that secures the glass surface 202 to the vehicle. The metal frame 204 is located at a perimeter of the glass surface 202 and includes a top edge 206, a bottom edge 208, a left edge 210 and a right edge 212. Each of the top edge 206 and the bottom edge 208 form a horizontal edge of the window 102, while each of the left edge 210 and right edge 212 form a vertical edge of the window. Although not shown, the edges of the glass surface 202 can extend underneath respective edges of the metal frame 204. A set 214 of defroster wires fills an area of the window 102. A top wire 216 of the set 214 of defroster wires is separated from the top edge 206 of the metal frame 204 by an antenna region 218. The antenna assembly 104 is disposed in the antenna region 218 in a top left corner of the window 102 (i.e., a corner defined by the intersection of the top edge 206 and the left edge 210). The glass surface 202, the antenna assembly 104 and the metal frame 204 are located in different layers along the y-axis, as discussed herein with respect to FIG. 5.

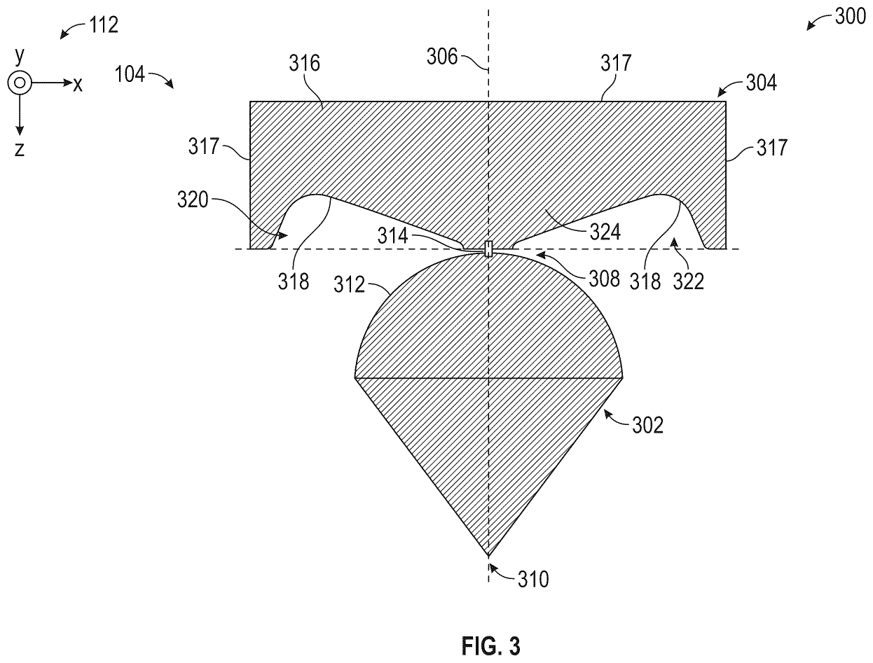

FIG. 3 shows a plan view 300 of the antenna assembly 104 in an illustrative embodiment. The antenna assembly 104 includes an antenna 302 and a ground plane 304. The antenna 302 can be a dipole antenna, monopole antenna, etc. The antenna assembly 104 (including both antenna 302 and ground plane 304) is symmetrical around an antenna axis 306. The antenna 302 includes a first end 308 and a second end 310 opposite the first end. The first end 308 includes a curved convex contour 312. A feed point 314 for the antenna 302 is located between the antenna and the ground plane 304 along the curved convex contour 312 of the first end 308 at the antenna axis 306. The feed point 314 allows a feed line (not shown) to connect the antenna 302 to the communication device 110 so that an RF signal can be transmitted and/or received.

The ground plane 304 connects to the antenna 302 at the feed point 314. The ground plane 304 includes a semi-rectangular sheet 316 having three linear edges 317 and one non-linear edge 318. A first recess 320 of the ground plane and a second recess 322 of the ground plane are formed in the non-linear edge 318. The first recess 320 and the second recess 322 are symmetrically arranged about the antenna axis 306 and define a connector section 324 along the antenna axis 306.

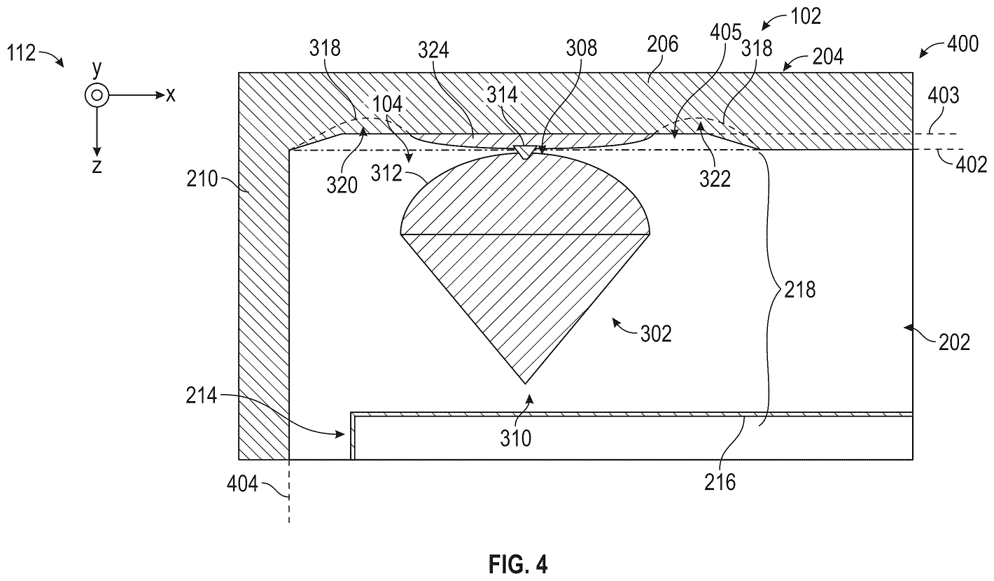

FIG. 4 shows a close-up view 400 of a left top corner of the window 102 in an illustrative embodiment. The close-up view 400 shows the top edge 206 and left edge 210 of the metal frame 204. The top edge 206 includes a horizontal cover line 402 and a recess cover line 403. The horizontal cover line 402 defines a separation between a visible region of the window and a part of the window hidden underneath the top edge 206. A frame recess 405 is formed at the top edge 206 to extend from the horizontal cover line 402 to the recess cover line 403. A portion of the window is visible in the frame recess 405. A vertical cover line 404 defines a separation between a part of the window that is visible from a part of the window that is hidden underneath the left edge 210.

The antenna assembly 104 is disposed on an outer surface of the window 102 with the antenna 302 visible and the ground plane, in part, underneath the metal frame 204. The antenna 302 is arranged with the first end 308 located at the horizontal cover line 402 and the second end 310 located distal from the top edge 206. The curved convex contour 312 of the first end 308 intersects the horizontal cover line 402 tangentially. Feed point 314 is located along the horizontal cover line 402. The second end 310 of the antenna 302 is located near the top wire 216 of the set 214 of defroster wires. A part of the connector section 324 is visible in the frame recess 403.

FIG. 5 shows a side view 500 of the window 102 and antenna assembly 104, in an illustrative embodiment. The y-axis is shown with respect to the window 102. The side view 500 includes a glass layer 502 including the glass surface 202, an antenna layer 504 including the antenna assembly 104, a conductive adhesive layer 506, and the metal frame 204. The metal frame 204 is separated from the glass surface by a separation gap h. In various embodiment, the separation gap h is about 6 millimeters. The antenna assembly 104 shows the antenna 302 and ground plane 304. The ground plane 304 is disposed on the glass surface 202 and within the separation gap h. The conductive adhesive layer 506 is disposed in the separation gap h to secure the ground plane 304 to the metal frame 204. The conductive adhesive layer 506 electrically couples the ground plane 304 to the metal frame 204, thereby grounding the antenna 302. In various embodiments, the conductive adhesive layer 506 includes a urethane adhesive.

Returning to FIG. 4, the first recess 320 and the second recess 322 are located in the separation gap between the metal frame 204 and the glass surface 202 and therefore covered by the top edge 206 of the metal frame 204. In addition, the connector section 324 of the ground plane 304 is covered by the top edge 206.

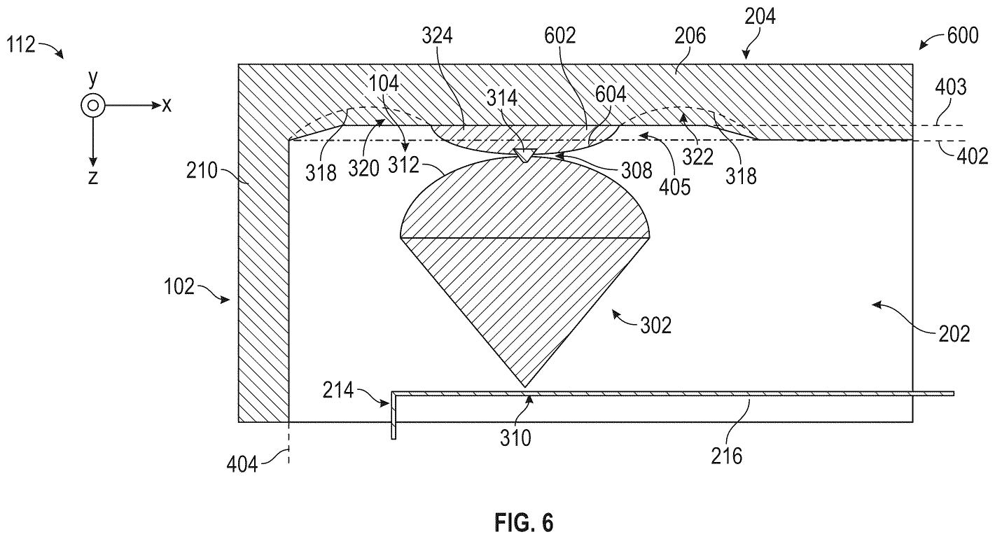

FIG. 6 shows a close-up view 600 of the left top corner of the window in another illustrative embodiment. The antenna assembly 104 is disposed on an outer surface of the window 102 with the antenna 302 visible. A first portion 602 of the connector section 324 is located in the separation gap and therefore hidden by the metal frame 204. A second portion 604 of the connector section 324 is visible or extends into the visible region of the window. Feed point 314 is therefore also located in the visible region of the window. The second end 310 of the antenna 302 is located near the top wire 216 of the set 214 of defroster wires.

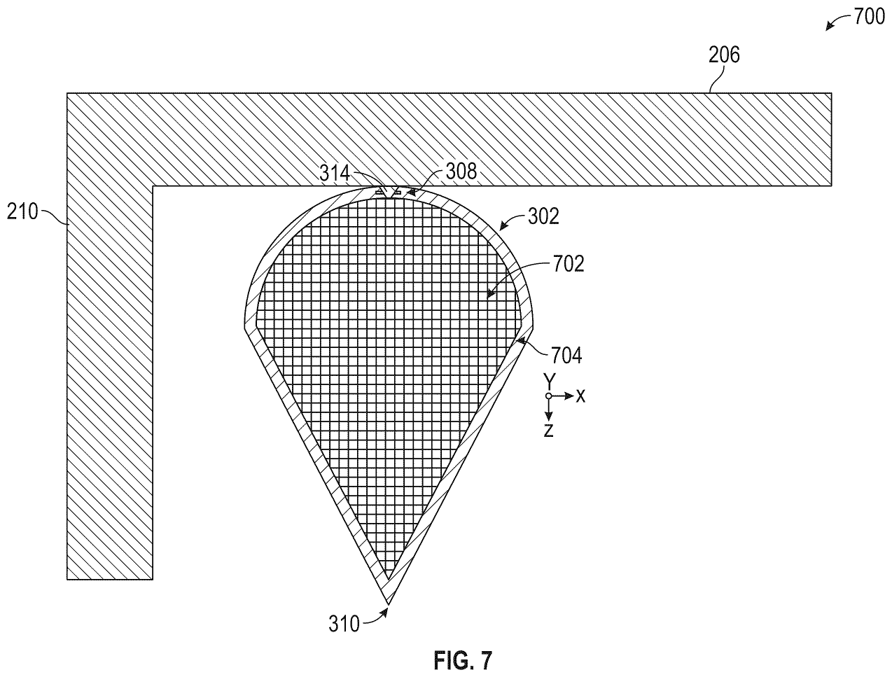

FIG. 7 shows a closeup view 700 of the antenna 302 of FIGS. 3, 4 and 6, in an illustrative embodiment. The antenna 302 includes a mesh 702 of electrical wires surrounded by an edge 704 that frames the mesh. The edge 704 is made of wires that are thicker than the electrical wires of the mesh 702. The feed point 314 is shown at the first end 308

The antenna assemblies can be formed on the glass surface 202 using various methods. In one method, the antenna is printed onto a transparent filament, or applique, that has an adhesive on one side to attach to the glass surface 202. In another embodiment, the antenna is printed on the glass itself.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An antenna assembly for a window of a vehicle, comprising:
an antenna disposed on a glass surface of the window, the antenna having a first end and a second end opposite the first end, the antenna disposed in a visible region of the window;
a feed point at the first end of the antenna; and
a ground plane disposed on the glass surface and connected to the antenna at the first end, wherein a metal frame of the window is on top of at least part of the ground plane and the ground plane is electrically coupled to the metal frame.

2. The antenna assembly of claim 1, wherein the ground plane includes a first recess and a second recess along an edge of the ground plane, the first recess and the second recess defining a connector section of the ground plane.

3. The antenna assembly of claim 2, wherein one of: (i) the metal frame is on top of the first recess, the second recess and the connector section; and (ii) a portion of the connector section is in the visible region of the window.

4. The antenna assembly of claim 1, wherein the ground plane is disposed within a separation gap between the glass surface and the metal frame, further comprising a conductive adhesive layer in the separation gap that electrically couples the ground plane to the metal frame.

5. The antenna assembly of claim 4, wherein the conductive adhesive layer includes a urethane adhesive.

6. The antenna assembly of claim 1, wherein the antenna is one of: (i) a monopole antenna; and (ii) a dipole antenna.

7. The antenna assembly of claim 1, wherein the window is a back window including a set of defroster wires and the antenna is disposed within an antenna region between the set of defroster wires and a top edge of the metal frame.

8. A window of a vehicle, comprising:
a glass surface;
a metal frame along a perimeter of the glass surface;
an antenna assembly disposed on the glass surface, the antenna assembly including:
an antenna having a first end and a second end opposite the first end, the antenna disposed in a visible region of the window;
a feed point at the first end of the antenna; and
a ground plane connected to the antenna at the first end, wherein the metal frame is on top of at least part of the ground plane and the ground plane is electrically coupled to the metal frame.

9. The window of claim 8, wherein the ground plane includes a first recess and a second recess along an edge of the ground plane, the first recess and the second recess defining a connector section of the ground plane.

10. The window of claim 9, wherein one of: (i) the metal frame is on top of the first recess, the second recess and the connector section; and (ii) a portion of the connector section is in the visible region of the window.

11. The window of claim 8, wherein the ground plane is disposed within a separation gap between the glass surface and the metal frame, further comprising a conductive adhesive layer in the separation gap that electrically couples the ground plane to the metal frame.

12. The window of claim 11, wherein the conductive adhesive layer includes a urethane adhesive.

13. The window of claim 8, wherein the antenna is one of: (i) a monopole antenna; and (ii) a dipole antenna.

14. The window of claim 8, wherein the window is a back window including a set of defroster wires and the antenna is disposed within an antenna region between the set of defroster wires and a top edge of the metal frame.

15. A vehicle, comprising:
a window having a glass surface and a set of defroster wires;
a metal frame along a perimeter of the glass surface, wherein a top edge of the metal frame and the set of defroster wires define an antenna region;
an antenna assembly disposed on the glass surface, the antenna assembly including:
an antenna disposed within the antenna region, the antenna having a first end and a second end opposite the first end, the antenna disposed in a visible region of the window;
a feed point at the first end of the antenna; and
a ground plane connected to the antenna at the first end, wherein the metal frame is on top of at least part of the ground plane and the ground plane is electrically coupled to the metal frame.

16. The vehicle of claim 15, wherein the ground plane includes a first recess and a second recess along an edge of the ground plane, the first recess and the second recess defining a connector section of the ground plane.

17. The vehicle of claim 16, wherein one of: (i) the metal frame is on top of the first recess, the second recess and the connector section; and (ii) a portion of the connector section is in the visible region of the window.

18. The vehicle of claim 15, wherein the ground plane is disposed within a separation gap between the glass surface and the metal frame, further comprising a conductive adhesive layer in the separation gap that electrically couples the ground plane to the metal frame.

19. The vehicle of claim 18, wherein the conductive adhesive layer includes a urethane adhesive.

20. The vehicle of claim 15, wherein the antenna is one of: (i) a monopole antenna; and (ii) a dipole antenna.
